(19) United States
(12) Patent Application Publication
(10) Pub. No.: US 2024/0221007 A1
(43) Pub. Date: Jul. 4, 2024

(54) SCALABLE MATRIX FACTORIZATION IN A DATABASE

(71) Applicant: Google LLC, Mountain View, CA (US)

(72) Inventors: Amir Hormati, Mountain View, CA (US); Lisa Yin, Redmond, WA (US); Umar Ali Syed, Edison, NJ (US); Mingge Deng, Kirkland, WA (US)

(73) Assignee: Google LLC, Mountain View, CA (US)

(21) Appl. No.: 18/605,172

(22) Filed: Mar. 14, 2024

Related U.S. Application Data
(63) Continuation of application No. 16/843,334, filed on Apr. 8, 2020, now Pat. No. 11,948,159.
(60) Provisional application No. 62/830,996, filed on Apr. 8, 2019.

(51) Int. Cl. G06Q 30/0201; G06F 16/22; G06F 16/2453; G06F 17/16; G06F 18/214; G06N 5/04

(52) U.S. Cl. CPC G06Q 30/0201; G06F 16/221; G06F 16/24535; G06F 17/16; G06F 18/214; G06N 5/04

(57) ABSTRACT

A method includes obtaining a query to create a matrix factorization machine learning model based on a set of training data and determining a model vector and a data vector based on the set of training data. The method also includes determining a dot product between the model vector and the data vector, determining matrices based on the dot product, and generating item vectors using a linear solver based on the matrices. The method also includes generating the matrix factorization machine learning model based on the item vectors and executing the matrix factorization machine learning model.

### CROSS REFERENCE TO RELATED APPLICATIONS

This U.S. patent application is a continuation of, and claims priority under 35 U.S.C. § 120 from, U.S. patent application Ser. No. 16/843,334, filed on Apr. 8, 2020, which claims priority under 35 U.S.C. § 119(e) to U.S. Provisional Application 62/830,996, filed on Apr. 8, 2019. The disclosures of these prior applications are considered part of the disclosure of this application and are hereby incorporated by reference in their entireties.

### BACKGROUND

Matrix factorization is a class of collaborative filtering algorithms used in recommender systems.

### SUMMARY

This document describes techniques, methods, systems, and other mechanisms for scalable matrix factorization. Matrix factorization can be used in recommender systems. A recommender system may be a model that predicts a “rating” or “preference” that a user might give to an item. Collaborative filtering is a technique used in recommender systems which filters for information or patterns assuming that users who have the same taste tend to like the same items.

Collaborative filtering is based on the assumption that users that like certain items like the items due to liking an inherent or latent set of features or factors about the item and each item contains its own inherent or latent set of features or factors that characterize the item. Mathematically, this translates to having a user-factor vector and item-factor vector which results in how the user feels about the item when the dot product of these two vectors is taken. Matrix factorization is an algorithmic representation of that idea.

Matrix factorization may be implemented in a scalable way in a database through various standard scalable database operations. For example, matrix factorization may be implemented in a Structured Query Language (SQL) using various queries that don't include non-scalable functions. Accordingly, implementing matrix factorization in a SQL based system with only scalable SQL functions may enable scalable matrix factorization in a database.

One innovative aspect of the subject matter described in this specification is embodied in methods that include the actions of obtaining a Structured Query Language (SQL) query to create a matrix factorization model based on a set of training data, generating SQL sub-queries that don't include non-scalable functions, obtaining the set of training data, and generating a matrix factorization model based on the set of training data and the SQL sub-queries that don't include non-scalable functions.

These and other versions may each optionally include one or more of the following features. For instance, in some implementations, generating a matrix factorization model based on the set of training data and the SQL sub-queries that don't include non-scalable functions includes defining, based on the training data, a model table, defining, based on the training data, a data model table, and generating the matrix factorization model based on both the model table and the data model table. In certain aspects, generating the matrix factorization model based on both the model table and the data model table includes determining two vectors based on both the model table and the data model table and generating the matrix factorization model based on a dot product of the two vectors.

In some aspects, generating the matrix factorization model based on both the model table and the data model table includes determining matrices based on the dot product of the two vectors, providing the matrices to a linear solver, obtaining item vectors from the linear solver, and generating the matrix factorization model based on the item vectors. In some implementations, generating SQL sub-queries that don't include non-scalable functions includes generating the SQL sub-queries such that all functions called in the SQL sub-queries are scalable.

In certain aspects, obtaining a Structured Query Language (SQL) query to create a matrix factorization model based on a set of training data includes obtaining a SQL query that specifies a model type, a source of the set of training data, a number of factors, a rating column in the set of training data, a user column in the set of training data, and an item column in the set of training data. In some aspects, the training data indicates ratings that users gave to items, and the matrix factorization model provides, for each of the users, predictions of ratings that the user would give to items for which the user did not give a rating.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Details of one or more implementations are set forth in the accompanying drawings and the description below. Other features, objects, and advantages will be apparent from the description and drawings, and from the claims.

### DESCRIPTION OF DRAWINGS

FIG. 1 is a block diagram of an example system for scalable matrix factorization.

FIG. 2A is a flow diagram that illustrates an example of a process for scalable matrix factorization.

FIGS. 2B and 2C illustrate an example of sharding in a process for scalable matrix factorization.

FIG. 3 is a block diagram of computing devices that may be used to implement the systems and methods described in this document, as either a client or as a server or plurality of servers.

Like reference symbols in the various drawings indicate like elements.

### DETAILED DESCRIPTION

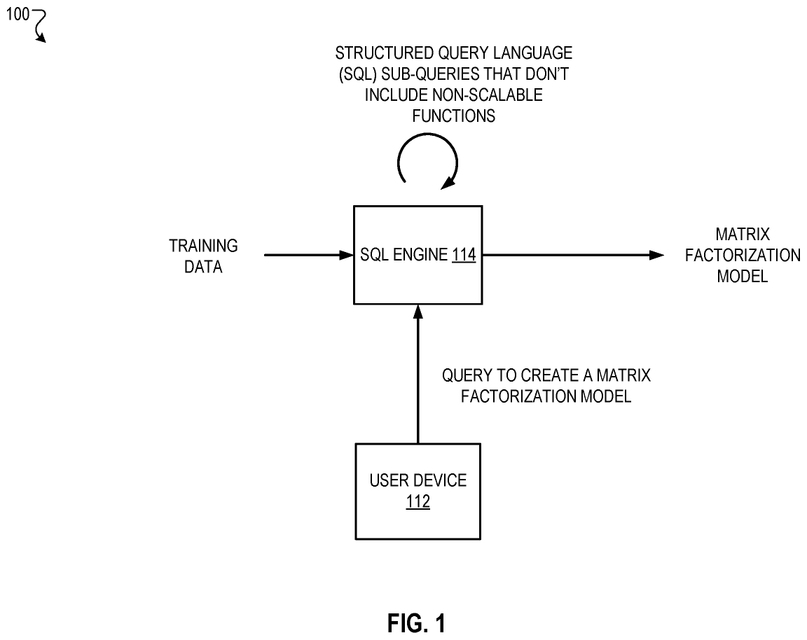

FIG. 1 is a block diagram of an example system 100 for scalable matrix factorization. Briefly, the system 100 includes a SQL engine 114 that receives, from a user device 112, a SQL query to create a matrix factorization model and, in response, creates the matrix factorization model.

The user device 112 may be a computing device used by a user to input an instruction to create a matrix factorization machine learning model. For example, a user may input a SQL query of “CREATE MODEL dataset.movie_recommendations(model_type=‘matrix_factorization’, num_factors=10, rating_col=‘rating’, user_col=‘movie_goer’, item_col=‘movie’) AS SELECT rating, movie_goer, movie FROM dataset.movie_data” into the user device 112 and the user device 112 may then send the SQL query to the SQL engine 114. In the example, the SQL query may instruct the SQL engine 114 to create matrix factorization model that uses ten factors to predict a rating that a particular movie goer would give to a particular movie based on training data that includes movies, movie goers, and ratings that the movie goers gave to the movies.

The SQL engine 114 may receive the query and generate sub-queries that don't include non-scalable functions based on the query. For example, the SQL engine 114 may create a sub-query that creates a model table by pre-ordering a portion of the training data so that a scalar dot product function may be used instead of more expensive unnest and join functions.

The SQL engine 114 may then execute the sub-queries and create the matrix factorization model. For example, the SQL engine 114 may obtain the training data, execute the sub-queries using the training data, and then create the matrix factorization model from the execution of the sub-queries.

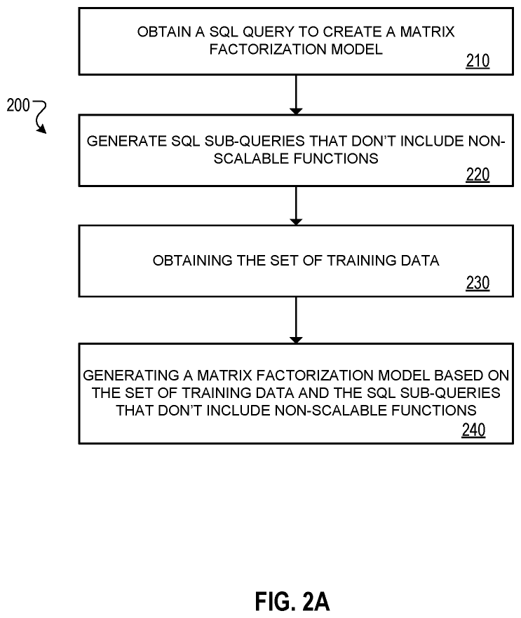

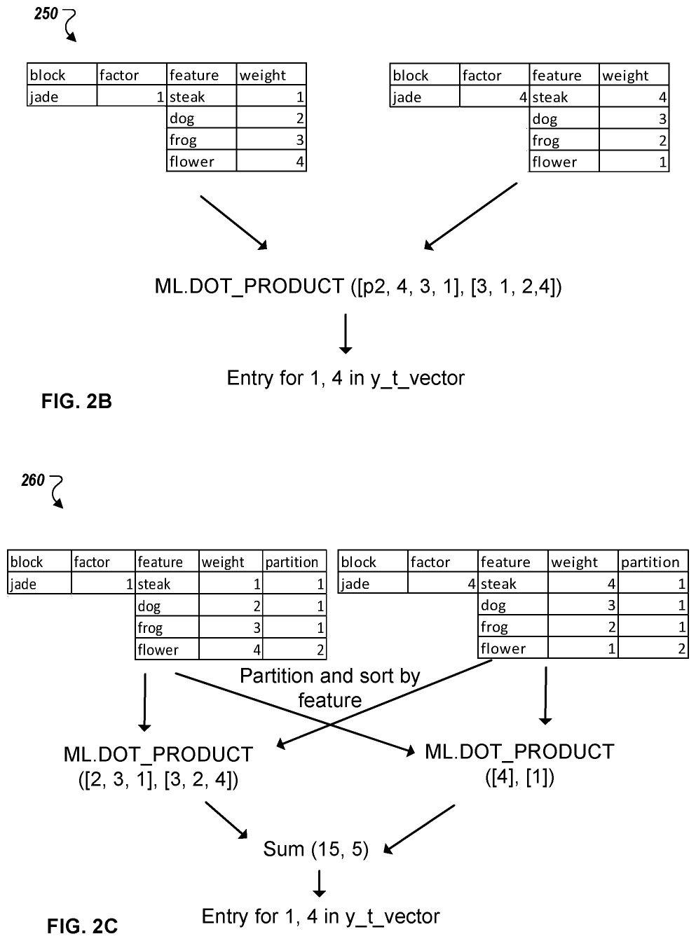

FIG. 2 is a flow diagram that illustrates an example of a process 200 for scalable matrix factorization. The process 200 may be performed by one or more computing devices, such as the one or more computing device that implement the SQL engine 114.

The process 200 includes obtaining a Structured Query Language (SQL) query to create a matrix factorization model based on a set of training data (210). For example, the SQL engine 114 may receive the query “CREATE MODEL dataset.movie_recommendations(model_type=‘matrix_factorization’, num_factors=10, rating_col=‘rating’, user_col=‘movie_goer’, item_col=‘movie’) AS SELECT rating, movie_goer, movie FROM dataset.movie_data” from the user device 112.

In some implementations, obtaining a Structured Query Language (SQL) query to create a matrix factorization model based on a set of training data includes obtaining a SQL query that specifies a model type, a source of the set of training data, a number of factors, a rating column in the set of training data, a user column in the set of training data, and an item column in the set of training data. For example, in the query above “model_type” specifies the model type of “matrix_factorization,” “num_factors” specifies ten factors, “rating_col” specifies that the rating column is named “rating” in the training data, “user_col” specifies that the user column is named “movie_goer” in the training data, and “item_col” specifies that the item column is named “movie” in the training data.

In some implementations, the training data indicates ratings that users gave to items, and the matrix factorization model provides, for each of the users, predictions of ratings that the user would give to items for which the user did not give a rating. For example, the training data may be a table that includes a table where each row specifies a user, an item, and a rating that the user gave the item, where the training data doesn't include a row for every pair of user and item, and the matrix factorization model predicts what a rating would be for a pair of user and item.

The process 200 includes generating SQL sub-queries that don't include non-scalable functions (220). For example, the SQL engine 114 may generate a SQL sub-query to multiply two matrices that does not include non-scalable functions. In some implementations, generating SQL sub-queries that don't include non-scalable functions includes generating the SQL sub-queries such that all functions called in the SQL sub-queries are scalable. For example, the SQL engine 114 may generate SQL sub-queries that include various SQL calls and parameters, where all of the SQL calls are scalar.

The process 200 includes obtaining the set of training data (230). For example, the SQL engine 114 may obtain the training data from a database in response to executing the sub-queries.

The process 200 includes generating a matrix factorization model based on the set of training data and the SQL sub-queries that don't include non-scalable functions (240). For example, the SQL engine 114 may execute all the sub-queries and as a result generate the matrix factorization model.

In some implementations, generating a matrix factorization model based on the set of training data and the SQL sub-queries that don't include non-scalable functions includes defining, based on the training data, a model table, defining, based on the training data, a data model table, and generating the matrix factorization model based on both the model table and the data model table. For example, the SQL engine 114 may generate the model table and the data model table in parallel, and then determine the matrix factorization model based on the model table and the data model table.

In some implementations, generating the matrix factorization model based on both the model table and the data model table includes determining two vectors based on both the model table and the data model table and generating the matrix factorization model based on a dot product of the two vectors. For example, the SQL engine 114 may determine two vectors from the model table and the data model table, determine the dot product of the vectors, and then generate the matrix factorization model based on the dot product.

In some implementations, generating the matrix factorization model based on both the model table and the data model table includes determining matrices based on the dot product of the two vectors, providing the matrices to a linear solver, obtaining item vectors from the linear solver, and generating the matrix factorization model based on the item vectors. For example, the SQL engine 114 may determine matrices based on the dot products of the two vectors, call a SQL function for a linear solver using two matrices as parameters, obtain item vectors from the linear solver in response to the call, and then generate the matrix factorization model based on the item vectors.

In an example of using the process 200 for matrix factorization, three columns may be used as input; the “user” column, “item” column, and a “value” column. As a result, a CREATE MODEL call might look like this:

CREATE MODEL dataset.movie_recommendations(

model_type=’matrix_factorization’, num_factors=10,

rating_col=’rating’, user_col=’movie_goer’,
item_col=’movie’) AS
SELECT rating, movie_goer, movie FROM dataset.movie_data

Num_factors and model_type may be required fields, and input_* can potentially depend on their data. If the data already has columns called rating, user, and item, they may not need it, but otherwise they can specify it. These options may be similar to input_label_cols.

Alternating Least Squares (ALS) is an algorithm that can be used to solve matrix factorization problems. For reference, a derivation of a formula follows. The solution may be rederived to include the intercepts. The goal of this derivation may be to get the final equation to look like one of an equation that is fed into a linear solver. To do so the cost function may be rewritten with the following substitutions to solve for the user weights and intercept:

$${r}_{ui}^{γ} ← {r}_{ui} - {γ}_{i} \\ \underline{{x}_{u}} ← ( {x}_{u} , {β}_{u} ) \\ \underline{{y}_{i}} ← ( {y}_{i} , 1 )$$

So the cost function looks like:

$$C = {\sum }_{u , i ∈ observed ratings} {( {r}_{ui}^{γ} - \underline{{x}_{u}^{T}} \underline{{y}_{i}} )}^{2} + λ ( {\sum }_{u} ( {‖ \underline{{x}_{u}} ‖}^{2} ) + {\sum }_{i} ( {‖ {y}_{i} ‖}^{2} + {γ}_{i}^{2} ) )$$

The last term of

$$\frac{dC}{d \underline{{x}_{u}}}$$

containing the yᵢ and γᵢ go to zero leaving:

$$\frac{dC}{d \underline{{x}_{u}}} = - 2 {\sum }_{i ∈ observed ratings for user u} ( {r}_{ui}^{γ} - \underline{{x}_{u}^{T}} \underline{{y}_{i}} ) \underline{{y}_{i}} + 2 λ \underline{{x}_{u}}$$

Scalar dot products are commutative, so the equation is rearranged to:

$$\frac{dC}{d \underline{{x}_{u}}} = - 2 {\sum }_{i ∈ observed ratings for user u} ( {r}_{ui}^{γ} - \underline{{y}_{i}^{T}} \underline{{x}_{u}} ) \underline{{y}_{i}} + 2 λ \underline{{x}_{u}}$$

This may be rewritten in matrix form where rᵤ^{γ} is a vector that contains element rᵤᵢ^{γ} for item i, each row of Y is yᵢ^{T} if i is observed for the user zero otherwise:

$$\frac{dC}{d \underline{{x}_{u}}} = - 2 \underline{Y} {r}_{u}^{γ} + 2 \underline{{Y}^{T}} \underline{Y} \underline{{x}_{u}} + 2 λ \underline{{x}_{u}}$$

Setting that to zero:

$$( \underline{{Y}^{T}} \times \underline{Y} + λ I ) \underline{{x}_{u}} = \underline{{Y}^{T}} {r}_{u}^{γ}$$

Similarly:

$$( {\underline{X}}^{T} \times \underline{X} + λ I ) \underline{{y}_{i}} = {\underline{X}}^{T} {r}_{i}^{β}$$

(X^{T}×X+λI) might be different for every i, as xᵤ may only be included in X if u,i was an observed value. This may leave a few problems to resolve since this may result in a significant change to the training. (X^{T}×X+λI) may be computed for every i and it may need to scale.

The bulk of the work for training may occur in a single query; the model weight query. The overall query may look like:

WITH model_table AS (
SELECT

data.item AS block,
model.factor AS factor,
ARRAY_AGG(model.weight
ORDER BY
model.feature) AS y_t_vector

FROM (

```
SELECT
  feature,
  factor,
  IF(factor = ″__INTERCEPT__″, 1.0, weight) AS weight
FROM
  ‘dataset.table_temp_user‘) model
```

JOIN

‘dataset.table_training_imported_data‘ data

ON

model.feature = data.user

GROUP BY

block,
factor),

```
  data_model_table AS (
  SELECT
```

data.item AS block,
model.feature AS row,
model.factor AS column,
model.weight AS value,
data.rating AS rating

FROM (

```
SELECT
  feature,
  factor,
  IF(factor = ″__INTERCEPT__″, 1.0, weight) AS weight
FROM
  ‘dataset.table_temp_user‘) model
```

JOIN (

```
SELECT
  data.user,
  data.item,
  data.rating - weights.intercept AS rating
FROM
  ‘dataset.table_training_imported_data‘ data
JOIN (
  SELECT
```

feature,
weight AS intercept

FROM

‘dataset.table_temp_user‘

WHERE

factor = ″__INTERCEPT__″) weights

ON
data.user = weights.feature) data

ON

model.feature = data.user)

```
SELECT
  feature,
  solution.factor AS factor,
  solution.weight AS weight
FROM (
  SELECT
```

block AS feature,
(
SELECT
ARRAY_AGG(STRUCT(matrix_row_index AS factor,

matrix_value AS weight))

FROM
ML.LINEAR_SOLVER( (

```
SELECT
  *
FROM
  UNNEST(a.matrix)),
(
SELECT
  *
FROM
  UNNEST(b.matrix)))) AS solution
```

FROM (

```
SELECT
  block,
  ARRAY_AGG(STRUCT(column AS matrix_row_index,
```

″1″ AS matrix_column_index,
value AS matrix_value)) AS matrix

FROM (
SELECT

block,
column,
SUM(rating * value) AS value

FROM

data_model_table

GROUP BY

block,
column)

GROUP BY
block ) AS b

JOIN (

```
SELECT
  block,
  ARRAY_AGG(STRUCT( matrix_row_index,
```

```
  matrix_column_index,
  IF (matrix_row_index = matrix_column_index,
```

matrix_value + @l2_reg, matrix_value) AS matrix_value)) AS matrix

FROM (
SELECT

block,
a_model.factor AS matrix_row_index,
b_model.factor AS matrix_column_index,
ML.DOT_PRODUCT(a_model.y_t_vector,
b_model.y_t_vector) AS matrix_value

FROM

model_table a_model

JOIN

model_table b_model USING (block))

GROUP BY
block ) AS a USING(block)) t,

t.solution;

This may be broken down as outlined below. The input data may be assumed to look like the below:

| user | item | rating |
|---|---|---|
| Adam | Aladdin | 5 |
| Adam | Bambi | 4 |
| Adam | Cars | 3 |
| Bec | Aladdin | 4 |
| Bec | Cars | 5 |

Two tables may be defined at the top of the function; model_table and data_model_table. These tables may be mainly used as set up to place the necessary vectors next to each other. model_table may set up the computation for Y^{T}Y for all u looks like the following:

WITH model_table AS (
SELECT

```
data.user AS block,
model.factor AS factor,
  ARRAY_AGG(model.weight ORDER BY model.feature) AS
  y_t_vector
FROM (
  SELECT
```

feature,
factor,
IF(factor = ″__INTERCEPT__″, 1.0, weight) AS weight

FROM

‘dataset.table_temp_item‘) model

```
JOIN
  ‘dataset.table_training_imported_data‘ data
ON
  model.feature = data.item
GROUP BY
  block,
  factor)
```

Each row of Y^{T} is ordered by the feature. The y_t_vector may be preordered so that the scalar function, ML.DOT_PRODUCT which will produce a dot product by multiplying two input vectors in order and avoid expensive UNNEST+JOIN combinations, can be called. This may rely on the fact that each feature may be unique and the same features will be left out for a given user/item for all of the rows of Y^{T}.

yᵢ←(yᵢ, 1) may be computed. Each yᵢ may be created. The full yᵢ model table may be joined against the input data in order to drop any items that a user hasn't rated and vice versa. Places in the query are swapped out when alternating in the weight computation. A user/block column allows computing Y^{T}Y for all users with one query.

The resulting table may look something like this:

| block | factor | y_t_vector |
|---|---|---|
| Adam | 1 | [0.2, 0.1, 0.3] |
| Adam | 2 | [0.1, 0.3, 0.3] |
| Bec | 1 | [0.3, 1.0] |
| Bec | 2 | [0.6, 0.1] |

The data_model_table may set up the computation Y^{T}rᵤ^{γ} as follows:

data_model_table AS (
SELECT

data.user AS block,
model.feature AS row,
model.factor AS column,
model.weight AS value,
data.rating AS rating

FROM (

```
SELECT
  feature,
  factor,
  IF(factor = ″__INTERCEPT__″, 1.0, weight) AS weight
FROM
  ‘dataset.table_temp_item‘) model
```

JOIN (

```
SELECT
  data.user,
  data.item,
  data.rating - weights.intercept AS rating
FROM
  ‘dataset.table_training_imported_data‘ data
JOIN (
  SELECT
```

feature,
weight AS intercept

FROM

‘dataset.table_temp_item‘

WHERE

factor = ″__INTERCEPT__″) weights

ON
data.item = weights.feature) data

ON

model.feature = data.item)

rᵤᵢ^{γ}←rᵤᵢ−γᵢ may be calculated. The resulting table may look something like this:

| block | row | column | weight | rating |
|---|---|---|---|---|
| Adam | Aladdin | 1 | 0.2 | 5 |
| Adam | Bambi | 1 | 0.1 | 4 |
| Adam | Cars | 1 | 0.3 | 3 |
| Adam | Aladdin | 2 | 0.1 | 5 |
| Adam | Bambi | 2 | 0.3 | 4 |
| Adam | Cars | 2 | 0.3 | 3 |
| Bec | Aladdin | 1 | 0.3 | 4 |
| Bec | Cars | 1 | 1.0 | 5 |
| Bec | Aladdin | 2 | 0.6 | 4 |
| Bec | Cars | 2 | 0.1 | 5 |

The actual computation of Y^{T}Y+λI for all u may look like:

```
SELECT
  block,
  ARRAY_AGG(STRUCT( matrix_row_index,
```

```
  matrix_column_index,
  IF (matrix_row_index = matrix_column_index,
```

matrix_value + @l2_reg,
matrix_value) AS matrix_value)) AS matrix

FROM (
SELECT

block,
a_model.factor AS matrix_row_index,
b_model.factor AS matrix_column_index,
ML.DOT_PRODUCT(a_model.y_t_vector,
b_model.y_t_vector) AS

matrix_value

FROM

model_table a_model

JOIN

model_table b_model USING (block))

GROUP BY
block

Each reduced item model is joined with itself for every user. Y^{T}Y is computed for every user. Y^{T}Y+λI is computed. The data is aggregated in a way that ML.LINEAR_SOLVER expects the table to look like. It is effectively an f×f matrix.

The resulting table looks something like this:

| block | matrix |
|---|---|
| Adam | [{1, 1, 0.14}, {1, 2, 0.14} {2, 1, 0.14}, {2, 2, 0.19}] |
| Bec | [{1, 1, 1.09}, {1, 2, 0.28}, {2, 1, 0.28}, {2, 2, 0.56}] |

The actual computation for Y^{T}rᵤ^{γ} looks like:

```
SELECT
  block,
  ARRAY_AGG(STRUCT(column AS matrix_row_index,
```

```
  “1” AS matrix_column_index,
  value AS matrix_value)) AS matrix
```

FROM (
SELECT

block,
column,
SUM(rating * value) AS value

FROM

data_model_table

GROUP BY

block,
column)

GROUP BY
block

| block | matrix |
|---|---|
| Adam | [{1, 1, 2.3}, {2, 1, 2.6}] |
| Bec | [{1, 1, 6.2}, {2, 1, 2.9}] |

An f×1 vector is created for each user that will get joined to the above query and sent to the linear solver.

```
SELECT
  feature,
  solution.factor AS factor,
  solution.weight AS weight
FROM (
  SELECT
```

block AS feature,
(
SELECT
ARRAY_AGG(STRUCT(matrix_row_index AS factor,

matrix_value AS weight))

```
FROM
  ML.LINEAR_SOLVER( (SELECT * FROM
  UNNEST(a.matrix)),
```

(SELECT * FROM UNNEST(b.matrix)))) AS solution

FROM

y_t_y_table AS b

JOIN

y_t_r_table AS a USING(block)) t, t.solution

Since ML.LINEAR_SOLVER is a TVF and takes in two tables, the arrays that were previously built are unnested. Y^{T}rᵤ^{γ} vectors are placed next to corresponding Y^{T}Y+λI matrix. The final output table would look like:

| block | factor | weight |
|---|---|---|
| Adam | 1 | 0.4 |
| Adam | 2 | 0.11 |
| Bec | 1 | 3.1 |
| Bec | 2 | 0.2 |

The following may be a model format used:

| item_feature | user_feature | factor_weight | intercept |
|---|---|---|---|
| Bambi | NULL | {“feature”: 1, | 0.1 |
| | | “value”: 1.6}, {“feature”: | |
| | | 2, “value”: 0.3}, | |
| NULL | Amir | {“feature”: 1, | 0.4 |
| | | “value”: 2.1}, {“feature”: | |
| | | 2, “value”: 1.2} | |

Instead of saving each factor as its own row, factors for each item and user may be saved into an array. For convenience, the intercept may be saved as its own column. A benefit from this representation is that ML.RECOMMEND may be written in a way that uses a cross-apply instead of a join, which will allow the query to finish.

In some implementations, an input dataset may be as follows:

| Column | Allowed Types |
|---|---|
| user | Any groupable type |
| item | Any groupable type |
| rating | Numeric |

The rating_col name may be mapped as the label_column_name so a separate name for the rating column may not be needed. The dataset may be strictly checked for three columns if data split isn't custom or seq and four columns if it is. The input columns may be “user”, “item” or “rating” verbatim, or specified using training options. Restriction might be loosed if all three columns are specified in OPTIONS.

Prediction for matrix factorization is a little different from prediction for K-Means and Generalized Linear Model. Namely, with the model itself, the user-item ratings that were passed in during training may be predicted. The unseen data in the matrix factorization case is the missing user-item values. Since matrix factorization determines two lower dimensional matrices, if multiplied by two, all the user-item rating values after prediction may be obtained. Thus, prediction may be run with only one input and also SELECT * FROM ML.PREDICT(model dataset.movie_recommendations) and SELECT * FROM ML.PREDICT(model dataset.movie_recommendations, table)

The second version of predict may filter out the first call based on the users and items that are in the given columns assuming they match the columns at training. For example, given the overall prediction table generated below for every separately seen user and movie example in training:

| movie_goer\movie | A | B | C | D |
|---|---|---|---|---|
| Adam | 1.3 | 2.0 | 1.3 | 4.2 |
| Barb | 2.3 | 1.2 | 4.2 | 2.4 |
| Charlie | 4.3 | 2.1 | 3.3 | 1.1 |
| Diane | 2.3 | 4.2 | 1.2 | 1.0 |

SELECT * FROM ML.PREDICT(model dataset.movie_recommendations) would return the entire table. If an input table was given and it only contained one column; movie_goer and two rows, Adam and Barb, then ML.PREDICT would return the yellow cells. If the input table only contained one column; movie and two rows, A and B, then ML.PREDICT would return the blue outlined cells.

Finally, if the input table looked like this:

| movie_goer | movie |
|---|---|
| Adam | C |
| Barb | A |
| Barb | D |
| Diane | D |

Then the output would be:

| predicted_rating | movie_goer | movie |
|---|---|---|
| 1.5269506389842873 | 460 | 251 |
| 0.9252882202876869 | 342 | 748 |

The user and item column names match the initial user and item columns that were passed in and cast to the original type of the column. To do this, a user and item ColType may be added to the column info in model.proto.

FIGS. 2B and 2C illustrate an example of a sharding in a process for scalable matrix factorization. In some implementations, due to the maximum size limit of a row, there can be an issue when constructing the y_t_vector if an item/user has too many user/item ratings. Each row may need to be less than 100 Mb. This issue may be compounded when ML.DOT_PRODUCT is called because the vector is joined with another vector that is the same size as itself and passed to the expression function. Thus, the maximum size of y_t_vector may be approximately 50 mb which, where y_t_vector is an array of floats, translates to around 780 k floats. This may not be a limit on the total number of unique items or users; it may be a limit on the maximum number of items that a single user has rated and the maximum number of users that have rated a single item which can be much less than the total number of unique items or users.

Since ML.DOT_PRODUCT may avoid joining the feature names when computing YtY by sorting the arrays prior to computation because it's agnostic to order, a process may continue to take advantage of that and shard the y_t_vectors, run ML.DOT_PRODUCT on each of the smaller arrays and then aggregate the result at the end to build the same YtY matrix. FIG. 2B shows on a high level how a single entry in the y_t_vector for a single user/block may be calculated and FIG. 2C shows on a high level a revision using sharding.

Assuming each feature gets a partition number, the SQL query may be modified to look like the below:

```
  WITH model_table AS (
  SELECT
```

data.item AS block,
model.factor AS factor,
data.user_partition_index AS partition_index,
ARRAY_AGG(model.weight
ORDER BY
model.feature) AS y_t_vector,
ANY_VALUE(data.item_count) AS count

FROM (

```
SELECT
  feature,
  factor,
  IF(factor = 0, 1.0, weight) AS weight
FROM
  ‘dataset.table_temp_item‘) model
```

JOIN

‘dataset.table_training_imported_data‘ data

ON

model.feature = data.user

GROUP BY

block,
factor,
partition_index)

...
SELECT
block,

ARRAY_AGG(STRUCT( matrix_row_index,

```
  matrix_column_index,
  IF (matrix_row_index = matrix_column_index,
```

matrix_value + @l2_reg,
matrix_value) AS matrix_value)) AS matrix

FROM (
SELECT

block,
matrix_row_index,
matrix_column_index,
SUM(matrix_value) AS matrix_value,
ANY_VALUE(count) AS count

FROM (

```
SELECT
  block,
  a_model.factor AS matrix_row_index,
  b_model.factor AS matrix_column_index,
  a_model.partition_index AS partition_index,
  ML.DOT_PRODUCT(a_model.y_t_vector,
```

b_model.y_t_vector) AS matrix_value,

```
  IF (a_model.count < 1, 1, a_model.count) AS count
FROM
  model_table a_model
JOIN
  model_table b_model USING(block)
WHERE
  a_model.partition_index = b_model.partition_index)
```

GROUP BY

block,
matrix_row_index,
matrix_column_index)

GROUP BY
block

The ‘partition_index’ may be generated during import to ensure that every feature has the same index in the same block. This may be done in the following manner:

```
SELECT
  user_id AS user,
  item_id AS item,
  rating - @__PARAMETER__global__intercept__ AS rating,
  user_count,
  item_count,
  CAST(ROUND(RAND( ) * item_count / 150000) + 1 AS INT64) AS
user_partition_index,
  CAST(ROUND(RAND( ) * user_count / 150000) + 1 AS INT64) AS
item_partition_index
FROM (
```

SELECT

*,
COUNT(1) OVER (PARTITION BY user) AS user_count,
COUNT(1) OVER (PARTITION BY item) AS item_count

FROM
‘dataset.table_frozen_data‘)

Each example is given a random partition depending on the item and user count for the user and item. The partition index will be used when calculating the YtY for each block. This partition index is dependent on both the number of items a user has rated or vice versa and the maximum number of floats to restrict y_t_vector to. If the approximate maximum is set to 150 k, then since the id is between 0-1, by multiplying it by the user or item count, and then dividing by 150 k, the same user_partition_index is generated for the same user and the same item partition_index for the same item. If there are less than 150 k items that a user has rated, this partition_index will always be 1, so the array isn't partitioned unless necessary and the arrays for different user blocks or item blocks can be partitioned differently.

For example, if the maximum number of items in an array is restricted to two, the following partition indices are determined:

| user | item | rating | user_count | rand_user | user_partition_index | item_count | rand_item | item_partition_index |
|---|---|---|---|---|---|---|---|---|
| jade | dog | 5 | 4 | 0 | 1 | 2 | 0 | 1 |
| jade | steak | 3 | 4 | 0.1 | 1 | 1 | 0.1 | 1 |
| jade | frog | 2 | 4 | 0.2 | 1 | 1 | 0.2 | 1 |
| jade | flower | 4 | 4 | 0.3 | 1 | 1 | 0.3 | 2 |
| john | dog | 2 | 3 | 0.4 | 1 | 2 | 0.4 | 2 |
| john | hammer | 4 | 3 | 0.5 | 1 | 1 | 0.5 | 2 |
| john | cake | 1 | 3 | 0.6 | 1 | 1 | 0.6 | 2 |

The range of item_partition_index is one to two while user_parition_index is mostly one. This is because the users have more ratings, four, than any item, two. (There are three items in item_partition_index one in order to generate partitions that matched an earlier example.)

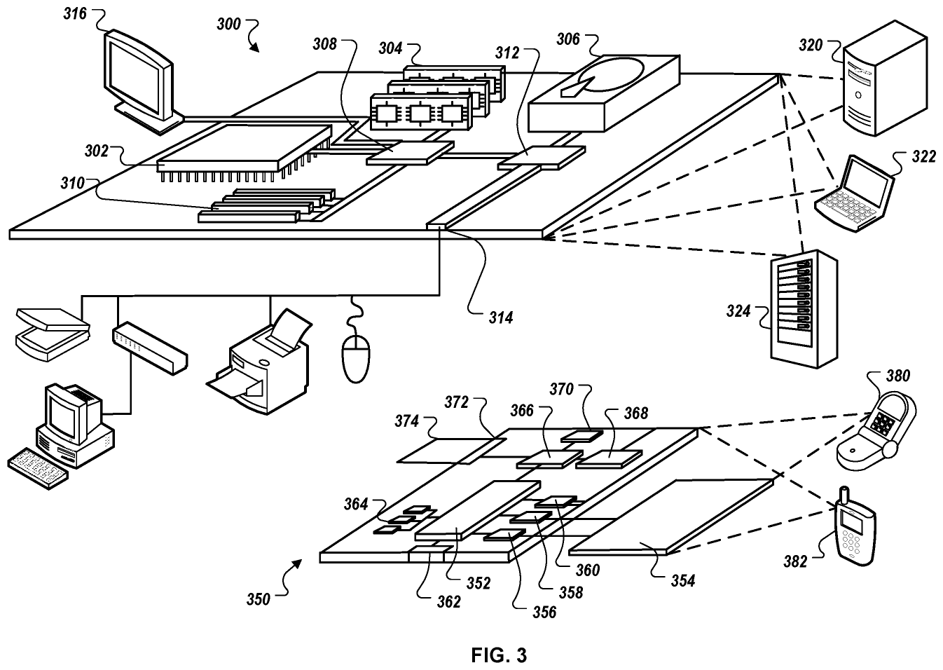

FIG. 3 is a block diagram of computing devices 300, 350 that may be used to implement the systems and methods described in this document, as either a client or as a server or plurality of servers. Computing device 300 is intended to represent various forms of digital computers, such as laptops, desktops, workstations, personal digital assistants, servers, blade servers, mainframes, and other appropriate computers. Computing device 350 is intended to represent various forms of mobile devices, such as personal digital assistants, cellular telephones, smartphones, and other similar computing devices. The components shown here, their connections and relationships, and their functions, are meant to be exemplary only, and are not meant to limit implementations described and/or claimed in this document.

Computing device 300 includes a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, are interconnected using various busses, and may be mounted on a common motherboard or in other manners as appropriate. The processor 302 can process instructions for execution within the computing device 300, including instructions stored in the memory 304 or on the storage device 306 to display graphical information for a GUI on an external input/output device, such as display 316 coupled to high speed interface 308. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 304 stores information within the computing device 300. In one implementation, the memory 304 is a volatile memory unit or units. In another implementation, the memory 304 is a non-volatile memory unit or units. The memory 304 may also be another form of computer-readable medium, such as a magnetic or optical disk.

The storage device 306 is capable of providing mass storage for the computing device 300. In one implementation, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 304, the storage device 306, or memory on processor 302.

The high speed controller 308 manages bandwidth-intensive operations for the computing device 300, while the low speed controller 312 manages lower bandwidth-intensive operations. Such allocation of functions is exemplary only. In one implementation, the high-speed controller 308 is coupled to memory 304, display 316 (e.g., through a graphics processor or accelerator), and to high-speed expansion ports 310, which may accept various expansion cards (not shown). In the implementation, low-speed controller 312 is coupled to storage device 306 and low-speed expansion port 314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. It may also be implemented as part of a rack server system 324. In addition, it may be implemented in a personal computer such as a laptop computer 322. Alternatively, components from computing device 300 may be combined with other components in a mobile device (not shown), such as device 350. Each of such devices may contain one or more of computing device 300, 350, and an entire system may be made up of multiple computing devices 300, 350 communicating with each other.

Computing device 350 includes a processor 352, memory 364, an input/output device such as a display 354, a communication interface 366, and a transceiver 368, among other components. The device 350 may also be provided with a storage device, such as a microdrive or other device, to provide additional storage. Each of the components 350, 352, 364, 354, 366, and 368, are interconnected using various buses, and several of the components may be mounted on a common motherboard or in other manners as appropriate.

The processor 352 can execute instructions within the computing device 350, including instructions stored in the memory 364. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 350, such as control of user interfaces, applications run by device 350, and wireless communication by device 350.

Processor 352 may communicate with a user through control interface 358 and display interface 356 coupled to a display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may be provided in communication with processor 352, so as to enable near area communication of device 350 with other devices. External interface 362 may provide, for example, wired communication in some implementations, or for wireless communication in other implementations, and multiple interfaces may also be used.

The memory 364 stores information within the computing device 350. The memory 364 can be implemented as one or more of a computer-readable medium or media, a volatile memory unit or units, or a non-volatile memory unit or units. Expansion memory 374 may also be provided and connected to device 350 through expansion interface 372, which may include, for example, a SIMM (Single In Line Memory Module) card interface. Such expansion memory 374 may provide extra storage space for device 350, or may also store applications or other information for device 350. Specifically, expansion memory 374 may include instructions to carry out or supplement the processes described above, and may include secure information also. Thus, for example, expansion memory 374 may be provided as a security module for device 350, and may be programmed with instructions that permit secure use of device 350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 364, expansion memory 374, or memory on processor 352 that may be received, for example, over transceiver 368 or external interface 362.

Device 350 may communicate wirelessly through communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, GPS (Global Positioning System) receiver module 370 may provide additional navigation- and location-related wireless data to device 350, which may be used as appropriate by applications running on device 350.

Device 350 may also communicate audibly using audio codec 360, which may receive spoken information from a user and convert it to usable digital information. Audio codec 360 may likewise generate audible sound for a user, such as through a speaker, e.g., in a handset of device 350. Such sound may include sound from voice telephone calls, may include recorded sound (e.g., voice messages, music files, etc.) and may also include sound generated by applications operating on device 350.

The computing device 350 may be implemented in a number of different forms, as shown in the figure. For example, it may be implemented as a cellular telephone 380. It may also be implemented as part of a smartphone 382, personal digital assistant, or other similar mobile device.

Additionally computing device 300 or 350 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method executed by data processing hardware that causes the data processing hardware to perform operations comprising:
obtaining, from a user device, a query to create a matrix factorization machine learning model based on a set of training data;
determining, based on the set of training data, a model vector and a data vector;
determining a dot product between the model vector and the data vector;
determining matrices based on the dot product;
generating, based on the matrices, item vectors using a linear solver;
generating the matrix factorization machine learning model based on the item vectors; and
executing the matrix factorization machine learning model.

2. The computer-implemented method of claim 1, wherein the operations further comprise:
defining, based on the set of training data, a model table; and
defining, based on the set of training data, a data table.

3. The computer-implemented method of claim 2, wherein determining the model vector and the data vector comprises:
determining the model vector based on the model table; and
determining the data table based on the data table.

4. The computer-implemented method of claim 1, wherein the set of training data comprises:
a rating column;
a user column; and
an item column.

5. The computer-implemented method of claim 4, wherein the rating column comprises ratings associated with items in the item column.

6. The computer-implemented method of claim 5, wherein executing the matrix factorization machine learning model comprises predicting a respective rating a particular user would provide for a particular item.

7. The computer-implemented method of claim 1, wherein the query comprises a source of the set of training data.

8. The computer-implemented method of claim 1, wherein the operations further comprise:
generating, based on the query, a plurality of sub-queries; and
executing the plurality of sub-queries.

9. The computer-implemented method of claim 8, wherein executing the plurality of sub-queries comprises:
determining the model vector and the data vector; and
pre-ordering the model vector and the data vector.

10. The computer-implemented method of claim 9, wherein determining the dot product between the model vector and the data vector comprises determining the dot product between the pre-ordered model vector and the pre-ordered data vector.

11. A system comprising:
data processing hardware; and
memory hardware in communication with the data processing hardware, the memory hardware storing instructions that when executed on the data processing hardware cause the data processing hardware to perform operations comprising:
obtaining, from a user device, a query to create a matrix factorization machine learning model based on a set of training data;
determining, based on the set of training data, a model vector and a data vector;
determining a dot product between the model vector and the data vector;
determining matrices based on the dot product;
generating, based on the matrices, item vectors using a linear solver;
generating the matrix factorization machine learning model based on the item vectors; and
executing the matrix factorization machine learning model.

12. The system of claim 11, wherein the operations further comprise:
defining, based on the set of training data, a model table; and
defining, based on the set of training data, a data table.

13. The system of claim 12, wherein determining the model vector and the data vector comprises:
determining the model vector based on the model table; and
determining the data table based on the data table.

14. The system of claim 11, wherein the set of training data comprises:
a rating column;
a user column; and
an item column.

15. The system of claim 14, wherein the rating column comprises ratings associated with items in the item column.

16. The system of claim 15, wherein executing the matrix factorization machine learning model comprises predicting a respective rating a particular user would provide for a particular item.

17. The system of claim 11, wherein the query comprises a source of the set of training data.

18. The system of claim 11, wherein the operations further comprise:
generating, based on the query, a plurality of sub-queries; and
executing the plurality of sub-queries.

19. The system of claim 18, wherein executing the plurality of sub-queries comprises:
determining the model vector and the data vector, and
pre-ordering the model vector and the data vector.

20. The system of claim 19, wherein determining the dot product between the model vector and the data vector comprises determining the dot product between the pre-ordered model vector and the pre-ordered data vector.
